(19) United States
(12) Patent Application Publication
(10) Pub. No.: US 2009/0172571 A1
(43) Pub. Date: Jul. 2, 2009

(54) LIST BASED NAVIGATION FOR DATA ITEMS

(75) Inventors: MARCEL VASILACHE, Tampere (FI); Mikko Antero Harju, Tampere (FI); Jani Kristian Nurminen, Lempaala (FI); Bogdan Florin Barliga, Tampere (FI); Ilkka Hemmo Haverinen, Tampere (FI); Kimmo Matias Parssinen, Tampere (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/966,858

(22) Filed: Dec. 28, 2007

(51) Int. Cl. G06F 7/10; G06F 17/30; G06F 3/048

(52) U.S. Cl. 715/764; 707/5; 707/E17.141

(57) ABSTRACT

A user interface provides for contextual navigation in locating desired content based on similarity/dissimilarity criteria. Each item that is identified in a device is provided with at least one multi-dimensional descriptor. A content of each item can be stored remotely from the device. A search criteria is selected that relates to the descriptor and a selected active item. A search is conducted to identify all other items identified in the device that have a relationship with the search criteria. The results are presented to the user and can be ranked according to a selected relationship order.

### BACKGROUND

1. Field

The disclosed embodiments generally relate to user interfaces and, more particularly to a user interface for contextual selection of media files or other data items.

2. Brief Description of Related Developments

In the current mobile devices, the constantly increasing storage capacities have resulted in the capability of storing very large numbers of audio, images, video and other multimedia files in the devices themselves. This large number of possible selections combined with rather limited user interface (“UI”) capabilities (e.g. reduced display size) can result in increasingly difficult navigation through the content stored in the device or locating desired content.

The usual approach for organizing the media files generally includes presenting the user with a sorted list according to specific criteria (release years, song/album titles, singer etc.). The user will typically have to browse and search the list to find a desired file, files, or data items.

It would be advantageous to be able to reduce the user effort when locating or browsing multimedia content or other data items.

### SUMMARY

The disclosed embodiments are directed to a method, apparatus, user interface and computer program product for providing each file and data item identified in a device with at least one multi-dimensional descriptor, selecting at least one component from the at least one multi-dimensional descriptor as an initial search criteria for a selected item, identifying in the device all other items that have a relationship with respect to the initial criteria, and presenting the identified files or data items to the user. An ordering relation induced by the selected search criteria can be used for presenting the closest matches in the proximity of the selected item.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates an exemplary user interface incorporating aspects of the disclosed embodiments;

FIG. 3 illustrates an exemplary user interface incorporating aspects of the disclosed embodiments;

FIG. 4 is a flowchart illustrating an exemplary process incorporating aspects of the disclosed embodiments;

FIG. 5 is a flowchart illustrating an exemplary process incorporating aspects of the disclosed embodiments;

FIGS. 6A and 6B are illustrations of exemplary devices that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which the devices of FIGS. 6A and 6B may be used.

### DETAILED DESCRIPTION OF THE EMBODIMENT(s)

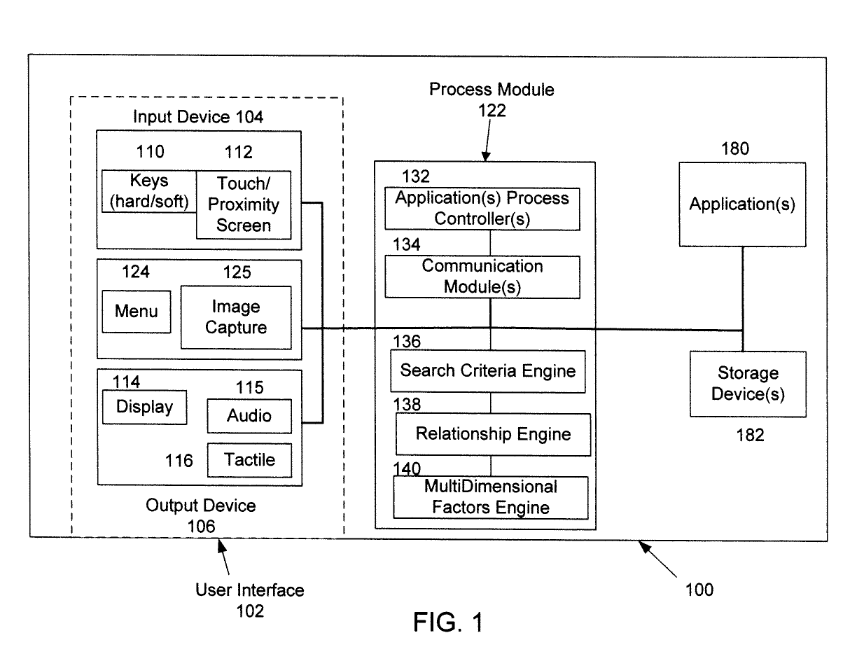

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The disclosed embodiments generally allow a user of a device or system, such as the system 100 shown in FIG. 1, to quickly and easily locate or browse data that is resident or stored in or on a device. The data can include for example, files, file content, data items, application elements, features and information. Content, as the term is used herein, generally refers to textual, visual or aural content or data published in a format. Content can include, for example, text, contacts, contact cards, geographical bookmarks, web links, images, sounds, audio, music, videos, animations, and instant messaging presence. Content can generally be stored in files, and for explanatory purposes, content files such as multimedia, audio, image, video files will be referenced. However, as the term is used herein, all content that can be stored and saved, shall be included. For example, in one embodiment the data is related to instant messaging or presence. The “file” or “content” related to this data could include the instant messaging application or the different contacts in the presence application. The disclosed embodiments are not limited to files or file content, but rather can include data of any kind. In this regard, the above noted terms may be used interchanegably.

For example, in one embodiment, the data or data items comprise contacts in an instant messaging application. Each contact is considered the data, or content, that will establish the criteria for the search.

In one embodiment, the search is not limited to a data type or file type of the anchor application. The search can be conducted across any or all data and file types stored in the device. For example, the criteria for the search is the name “George”, that is selected from a contact list in an instant messaging application. The search can include determining whether the word “George” is present in any other data source or file in the device. These can include, for example, music files, image files, contact files, or instant message presence application.

Although the disclosed embodiments will generally be described with respect to data, content or files stored or located in a device, the data, content and files could also be remotely located from the device. In one embodiment, where the content is remotely located, the device can include metadata that relates the content identified in the device to the actual content that is stored remotely.

The aspects of the disclosed embodiments allow a user of a device 100 to select one or more search criteria related to an active or selected file or content on a device, such as a music file. Using the search criteria, a search is executed in the device 100 for other files or content 100 that have some relationship with the active file, relative to the search criteria. In one embodiment, the relationship may only be the search criteria. The results of the search can be displayed on the display of the device 100. Further criteria can be selected from the search criteria options being presented and a subsequent search executed to find files or content that match, are a near match or have some relationship or similarity to all of the activated search criteria and the selected file or content. The aspects of the disclosed embodiments allow step-by-step navigation in locating desired content, in a list based, contextual navigation system.

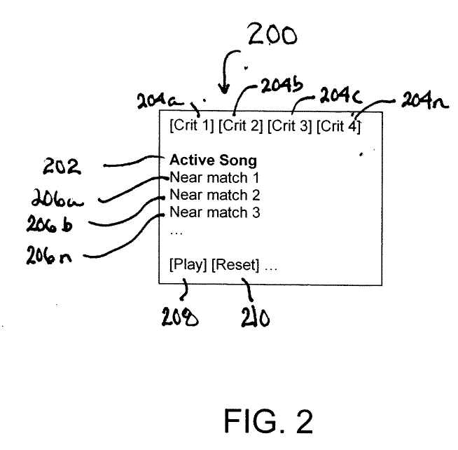

FIG. 2 illustrates one example of a user interface 200 incorporating aspects of the disclosed embodiments. The user interface 200 shown is in the form of a screen shot of the display of the device 100 of FIG. 1, in a multimedia mode. The user interface 200 can include a descriptor 202 for the active file or content, search criteria elements 204a-204n, search results 206a-206n, a play control 208 and a reset control 210. In alternate embodiments the user interface 200 can include such other suitable factors for organizing media files and presenting the user a sorted list according to specific criteria.

In one embodiment, certain factors can be associated with each content/data item or file stored or active in the device 100. These factors can generally represent certain features or descriptive aspects that can be associated with such content. These factors shall be referred to herein as multi-dimensional factors or descriptors. For example, with respect to music files, the dimensions or factors can include descriptors such as tempo, rhythm, loudness or energy, vocal characteristics of the interpreter, singer, group, band, title, release year, instrument, environment, genre and others. With respect to photos or image files, the factors can include time and date taken, location, color balance, intensity variations, exposure value, lens used, aperture, camera model and any other factor or descriptor related to photos, for example. The factors are generally specific to the file content or data type. For example, when the data type is instant messaging, the factors can include contact information. Other factors and search criteria can include for example, instant message status, presence indicators, geographic location, online status or any other suitable factor that can be associated with the underlying application of the selected file. For different file types the search criteria can also include for example, metadata or the lack of metadata, the file name, the file type, the file properties, creation dates/times, word count, play count, language, origin or extension. These lists are merely exemplary and are not intended to include all factors or criteria that might be used to describe, categorize or quantify a file or content type or search for related files. For each content file, a suitable list of features or factors can be developed and stored. Although the embodiments disclosed herein are described with reference to content files, it should be understood that any suitable files, information lists or application lists can be used other than including content files. For example, in one embodiment, the list of search results can include all instant messaging contacts stored in the device. The user can select one or more of the search criteria 204a-204n to narrow the list of instant messaging contacts. Similarly, with an address list, the search criteria 204a-204n can correspond to factors relevant to members of the list. For example, a relevant criterion in this context is membership in a given set of persons, such as messages from family members. A search for certain types of address contacts can be carried out and narrowed as described herein. This can allow a user to move from one information item to another, or the next information item, in a manner as established by the search criteria.

In one embodiment the files, content and data items described herein can be stored in or on the device 100. Although as described herein the content is stored in the device, in one embodiment, the files, content and data items can also be located or stored remotely from the device 100, such as on an external server or hard drive. In this case, the information related to the remotely stored content handled by the user device is the metadata stored within the device, except when content is of a type that is being played or presented by the device.

In one embodiment, each file shall be associated with one or more multi-dimensional factors or descriptors. The factors can be set by the user for each file, file types can be preset with such factors, or such relevant factors can be automatically extracted on the device itself. Thus, in the example of music content, each music file will have associated with it one or more multi-dimensional factors that can be used to identify and categorize various aspects of the particular music file.

As shown in FIG. 2, a music file 202 has been selected by the user and can be considered the active song or file. Although the active file will generally be described as stored in the device, the active file could also be located remotely from the device. In one embodiment, the content for a selected file can be streamed to the device from the remote location in any suitable manner. Thus, actual file storage on the device for the anchor file or content, or any other file, is not required. This initial selection of music file 202 is generally referred to as the anchor selections. The initial selection of the active song 202 can be done directly, by a hierarchic search of the database by keypad, touchpad or voice input, for example. Examples of the search criteria can include for example artist name, album name, genre, tempo, release year, for music data. In one embodiment, the anchor selection can be actively playing on the device or, alternatively, only the file name is displayed. Selection or search criteria 204a-204n can be displayed on the user interface 200. In one embodiment, the search criteria 204a-204n are displayed as a list along one or more side areas of the user interface. As shown in FIG. 2, the search criteria 204a-204n are positioned along a top edge of the user interface 200. The search criteria 204a-204n are generally active and selectable. In one embodiment, the actual criteria may be displayed in the relative locations shown in FIG. 2. In alternate embodiments, the locations for the search criteria may only be links to a more detailed description of the criteria. For example, positioning a cursor or other selection tool at or near the location of the criteria 204a-204n might generate a pop-up or similar window that details the actual or additional search criteria. In one embodiment, each search criteria 204a-204n may include one more search fields associated therewith. The search field would allow the user to enter search parameters in order to user-define the search criteria in an efficient manner. In the example related to the pop-up window, in one embodiment, when the selection tool is positioned near the search criteria fields 204a-204n, a pop-up can appear that includes at least one search field for entering the independent search criteria.

The search criteria 204a-204n can be directly related with the elements of the multi-dimensional representation or descriptor. By using the multi-dimensional representation, one can quickly navigate the device 100 database starting with the anchor selection and repeated applications of various selection criteria. Thus, for example, a search using the criterion “rhythm” would order the elements that are returned from the search based on the value associated with it. In this example, the “value” can be the number of beats per second (“bps”). If a criteria is value dependent, a second descriptor can appear after choosing the first criteria. For example, if a criterion is value dependent, the value would be 120 beats per second and not just “beats per second.” In this example, the second descriptor that appears after choosing the first allows the user to set the value for the criteria.

In one embodiment, the user can change the criteria. For example, if one criteria is beats per minute greater than 100 (bpm>100), the user can change the number as well as the logical operator. Alternatively, for the same criteria, the user may be able to add or remove the number. As another example, the criteria is bpm>100±X. For this particular example, the user might be able to select the ± operator and the value “X”. The selection can be based on the ease with which the search can be narrowed. For example, it might be easier to narrow a search by raising or lower the number using the extra factor X. The device can also include small key inputs that allow the user to change the number X, up and down in suitable increments, without having to enter the number itself.

One or more selection criterion can be used in conjunction with the active file to develop a list of matches, based on all the activated selection criteria. As shown in FIG. 2, the search executed here has resulted in a list 206a-206n of closest matches, based on the active selection criteria.

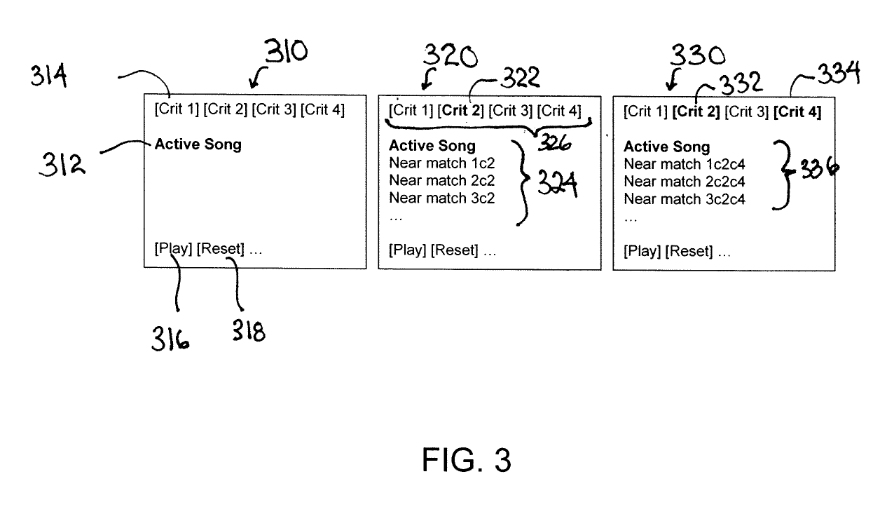

FIG. 3 illustrates another example of a user interface incorporating aspects of the disclosed embodiments. In this example, a sequence of screen shots are shown, 310, 320 and 330, running from left to right. In screen shot 310, the user has selected an anchor song 312, also referred to as the active song. Although the anchor song 312 is depicted as being highlighted in bold, in alternate embodiments any suitable highlighting mechanism can be used. For example, in one embodiment a different activation indicator can be used to identify the active criteria, such as for example, reversed background and foreground colors. The highlighting of the active criteria is not intended to be limited by the embodiments disclosed herein.

In conjunction with the selection of the anchor song 312, one or more search criteria 314 can be displayed. In one embodiment the search criteria 314 can appear in conjunction with the selection of the anchor song 312. The criteria 314 may be unique to the selected anchor song or may be preset values. The criteria 314 can automatically be generated and then customized by the user. For example, in one embodiment a list might automatically populate the screen. In one embodiment, the list can comprise a graphical representation of the information or content. For example, if the search is of an album, the album cover or a portion thereof can be displayed. In a situation where 3-D graphics are used, the list can also be shown as an xyz map or such other three-dimensional image or graphic. The user can then select/deselect criteria as desired. The user interface can also include controls for other functions of the device, such as play 316 and reset 318.

As shown in FIG. 2, in screen 320, the user has activated Crit 2 322. The activation mechanism for the criteria can be any suitable user interaction. A list 324 of other songs is produced and brought into view. Each item in the list 324 is described as a “Near match” to the selection criteria 322 and active song 312. Although only three returned results are presented, in alternate embodiments any suitable number of search results can be provided. The number of search results displayed can depend upon a number of factors, including the screen size of the device or the quality of the match. In one embodiment, the search results can be grouped, particularly if a large screen is used. In one embodiment the search criteria can be coded, such as by color. In alternate embodiments, any suitable coding of the search criteria can be implemented. In the example where the search criteria selection items are coded by color, the search results can be grouped according to the respective criteria to which each belongs.

In screen 330, the user has activated a second dimension, Crit 4 334, in conjunction with Crit 2, 332. The list 324 will be re-ordered and a new list 336 is generated with the closest matches appearing as “Near match”, taking into account both Crit 2 and Crit 4. The distance in this case is for instance “the sum of distances from these two dimensions.” Generally, all of the search criteria can be viewed as introducing a distance value to the active item. We can have search predicates with 0 and 1 as output (no/yes) or smoother matches, as in the examples from the paragraph. In all cases we can imagine a significance threshold to prune down the list to top matches. When combining several criteria, a possible weighting will aim at preserving the range of the overall distance and evenly balancing the contribution of the components. As an example, if we combine only predicates the weights can be 1/N (N—number of currently active criteria) making the range of possible value [0→1]. Hence, for instance, 0.66 can be used as a significance threshold. If we have smooth components the weights for them can be 1/N*W, where W is chosen as to have its maximal distance for that component limited to 1 or, perhaps more relevant, the standard deviation for these distances to be unity. For instance, if one criterion is “date” then the time interval between the active file and the other files is used to sort the list. If the search criterion is geographic “location”, then an actual distance between locations can be used. For several search criteria which have a corresponding “distance” measure when jointly activated there is a need to produce a single distance value to order the list. In one embodiment, a weighted Euclidean measure can be used, with the weights aiming at equally balancing the contributions of individual measures (e.g. combining time with spatial distance), and/or also allowing for a unique, perhaps user specified, significance threshold. In one embodiment, depending on the distance measure which results from the selected criteria, the active item can be placed at the top (as illustrated in FIG. 2. and FIG. 3.) but also in the center of the list. The center placement is best suited for cases where a “signed” ordering relation can be established with the selected search criteria (e.g. “time” can be before or after the timestamp of the selected item however, “distance” can't have a negative meaning). In one embodiment, when more than one search criteria is selected, it is not necessary that each item in the list 336 share each one of the selected criteria. Items presented in the list 336 may still be presented even if they only share some of the criteria. For example, an item that only shares two out of three selected criteria may still be presented to the user in the list 336. The list can be ordered so that the most relevant matches are presented first, or in a more significant manner, while less relevant items are ordered later in the list, or do not stand out in comparison to more relevant items. For example, a near match that only shares some of the selected criteria could appear in a dimmed or grayed out fashion in order to illustrate its relevance. Alternatively, the percentage of relevance or match can be presented adjacent to the item in the list. In other embodiments, such a near or partial match can be presented in any suitable manner that informs the user as to the relevance of the item with respect to the selection criteria.

While the ordering relation with respect to FIGS. 2 and 3 is generally referred to as “near match” or “similar”, in one embodiment the relation could be one of negation. In this situation, the user is seeking to locate the most dissimilar items as compared to the currently selected one. The search result set can identify the most dissimilar items in a rank order. In one embodiment, the similarity or dissimilarity of an item can be identified by the level of highlight applied to the item. For example, a color/intensity coding can illustrate the distance or relationship to the selected item. A short distance or very similar item will be recognized by an intense or bold descriptor while a poor match, partial match or long distance between the item and the anchor item can be represented by nearly fading the item from view at the bottom of the list. In alternate embodiments, any suitable ranking or ordering of results in a search result set can be used, as can any suitable method to display the results.

In one embodiment, the active song 312 can be exchanged with any member in the current result list. For example, in screen 320, the active song 312 can be exchanged with any one of the members or results in the list 324. Similarly, the selection criteria 326 can be switched on or off, or directly and independently activated and disabled at times. In this fashion, a user can navigate across media files based on neighboring relations formed with the enabled selection criteria.

The disclosed embodiments allow a user to see what is currently being played or selected, when working with multimedia files, and see matches, and near matches to the current selection. These matches and near matches can include, for example, possible next songs or contenders. In one embodiment the user can select which criteria are to be present and which criteria should not be present with the contenders.

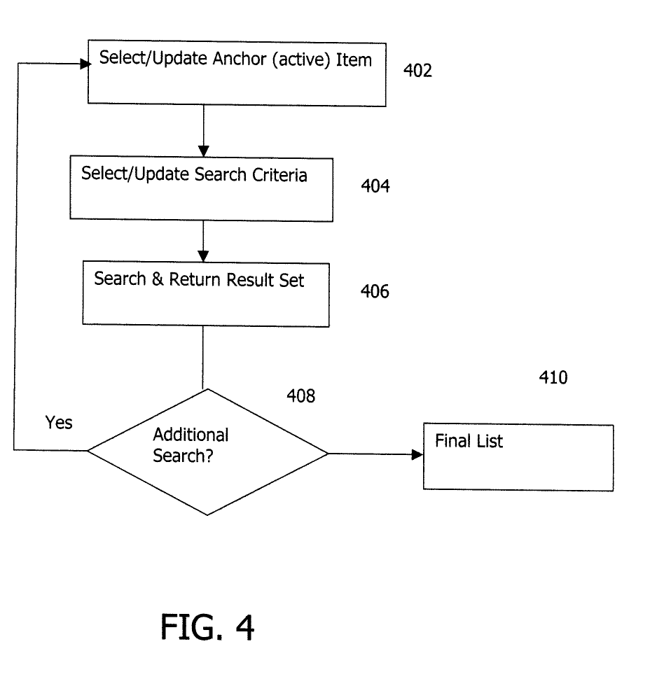

FIG. 4 illustrates one example of a process flow in accordance with the disclosed embodiments. The anchor file is selected 402. The anchor file can be the initial file the user is interested in and wishes to compare to other files in the device. In one embodiment the anchor file is selected 402 from files or data items associated with applications stored or accessibly by the device. In an alternate embodiment, the anchor file can be imported, streamed or uploaded from another location. At least one search selection criteria is selected 404. The selection criteria can automatically be displayed on the device as selectable links or objects. In one embodiment, the initial set of selection criteria is automatically set by the device, depending upon the file type. The user may then have the option to add, delete or search for additional search selection criteria. In one embodiment, the search criteria can be activated or deactivated, selected or un-selected, as desired by the user. Selected criteria can be highlighted in any suitable fashion to differentiate the selected criteria from the un-selected criteria. Additional search selection criteria can be stored in the device or imported from another service or location.

A search is executed and initial search result set returned 406. The search results can be ordered in any suitable manner. In one embodiment the most relevant results are displayed to the user in a more prominent fashion than non or less relevant search results. If the user is satisfied with the result set, the search ends 410. If additional refinement is desired or additional searching 408, the search criteria can again be set by deleting or adding 404 search criteria.

After each search the user can reposition the active item as one of the current matches in the list 402. He is also free to modify the list of selected search criteria 404 to widen or narrow the scope of his search.

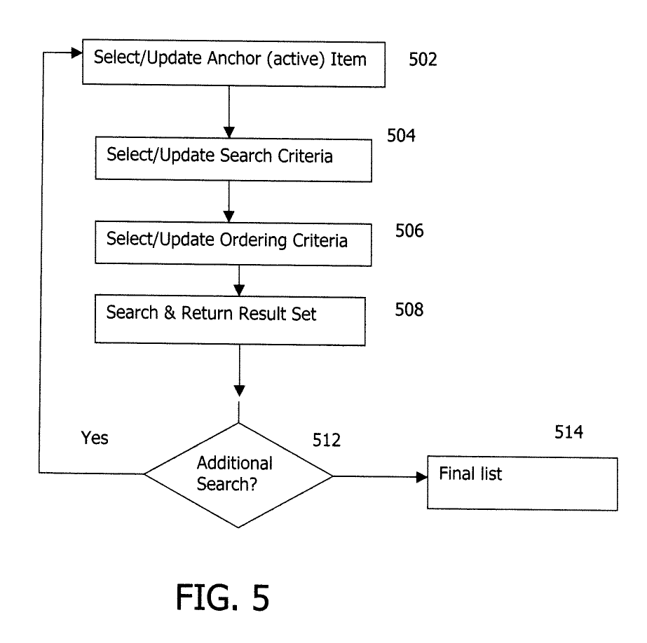

FIG. 5 illustrates an example where the ordering criteria is also established prior to the search. In this example, the user is able to also select 506 the ordering type, which can include searching for similar or dissimilar items. This selection allows for a negation alternative, where the user seeks to locate the most dissimilar items relative to the currently selected item. In one embodiment, the selection of new search criteria can be optional if the default criterion that are provided with the initial search are acceptable. The selection of visible criteria can be the first search option presented to the user, with alternative or additional searching being presented as an option.

In one embodiment, the list of matching items can be dynamically updated as the user activates/deactivates selected search criteria 404 or 506. There is no need for a specific user input to perform the actual search 406 or 508. The user is free to alternate between 402 and 404 or 502, 504 and 506 at all times. In this way the user can navigate the data items based on similarity/dissimilarity relations as imposed by the active search criteria in the context of the currently active item.

Referring to FIG. 1, the system of the disclosed embodiments can include an input device 104, output device 106, process module 122, applications module 180, and storage/memory 182. The components described herein are merely exemplary and are not intended to encompass all components that can be included in the system 100. The input device 104 is configured to allow a user to input data and commands to the system or device 100. The output device 106 is configured to allow information and data to be presented to the user via a user interface of the device 100. The process module 122 is generally configured to execute the processes and methods of the disclosed embodiments. The application process controller 132 can be configured to interface with the applications module 180 and execute applications processes with respects to the other modules of the system 100. The communication module 134 is configured to allow the device to send communications and messages, such as text messages, chat messages and email. The communications module 134 is also configured to receive communications from other devices and systems. The multidimensional factors engine 140 is configured to allow descriptors for different file types to be established. The descriptors can be user established using for example a settings application of the device. In one embodiment the descriptors can automatically be attached to the file type or imported from another database. The relationship engine 138 is configured to establish different ordering relationships. For example, while it is possible to conduct a search for items similar to certain search criteria, it is also possible to conduct a search for items that are most dissimilar to the search criteria. The relationship engine 138 allows for establishing the desired search ordering criteria and the selection of the particular ordering and relationship criteria during a search. The search criteria engine 136 is configured to allow for the selection of the various search criteria associated with the disclosed embodiments. The search criteria engine 136 allows for search criteria to be created, imported and associated with the various files and file types stored in the device. In one embodiment, the search criteria engine 136 can also execute the search of files and file types in the device 100, or coordinate the search in conjunction with the other modules of the device 100.

The applications module 180 can include any one of a variety of applications that may be installed, configured or accessible by the device 100. In one embodiment the applications module 180 can include media player and multimedia applications.

In one embodiment, the system 100 comprises a mobile communication device. The mobile communication device can be Internet enabled. The input device 104 can also include a camera or such other image capturing system. The applications of the device may include, but are not limited to, data acquisition (e.g. image, video and sound) and multimedia players (e.g. video and music players). In alternate embodiments, the system 100 can include other suitable devices and applications for capturing and storing images and transferring the images to an online service.

While the input device 104 and output device 106 are shown as separate devices, in one embodiment, the input device 104 and output device 106 can be combined and be part of and form, the user interface 102. The user interface 102 can be used to display information pertaining to multi-media content as will be described below.

In one embodiment, the user interface of the disclosed embodiments can be implemented on or in a device that includes a touch screen display or a proximity screen device. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

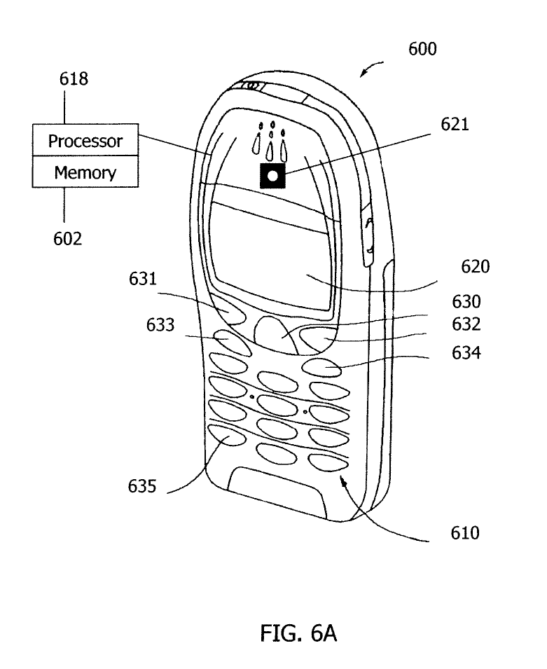

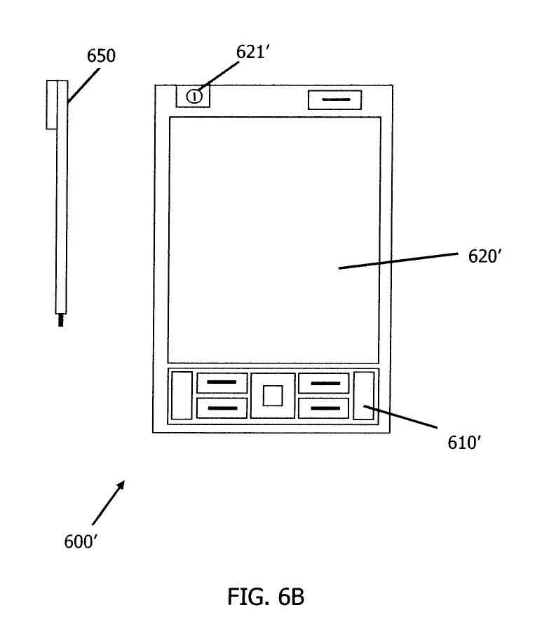

Some examples of devices on which aspects of the disclosed embodiments can be practiced are illustrated with respect to FIGS. 6A and 6B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and a scroll function can be used to select item(s) from the list that is provided.

As shown in FIG. 6A, in one embodiment, the terminal or mobile communications device 600 may have a keypad 610 as an input device and a display 620 for an output device. The keypad 610 may include any suitable user input devices such as, for example, a multi-function/scroll key 630, soft keys 631, 632, a call key 633, an end call key 634 and alphanumeric keys 635. In one embodiment, the device 600 includes an image capture device such as a camera 621 as a further input device. The display 620 may be any suitable display, such as for example, a touch screen display or graphical user interface. The display may be integral to the device 600 or the display may be a peripheral display connected or coupled to the device 600. A pointing device, such as for example, a stylus, pen or simply the user's finger may be used in conjunction with the display 620 for menu selection and other input and commands. In alternate embodiments any suitable pointing or touch device may be used. In other alternate embodiments, the display may be a conventional display. The device 600 may also include other suitable features such as, for example a loud speaker, tactile feedback devices or connectivity port. The mobile communications device may have a processor 618 connected to the display for processing user inputs and displaying information on the display 620. A memory 602 may be connected to the processor 618 for storing any suitable information, data, settings and/or applications associated with the mobile communications device 600.

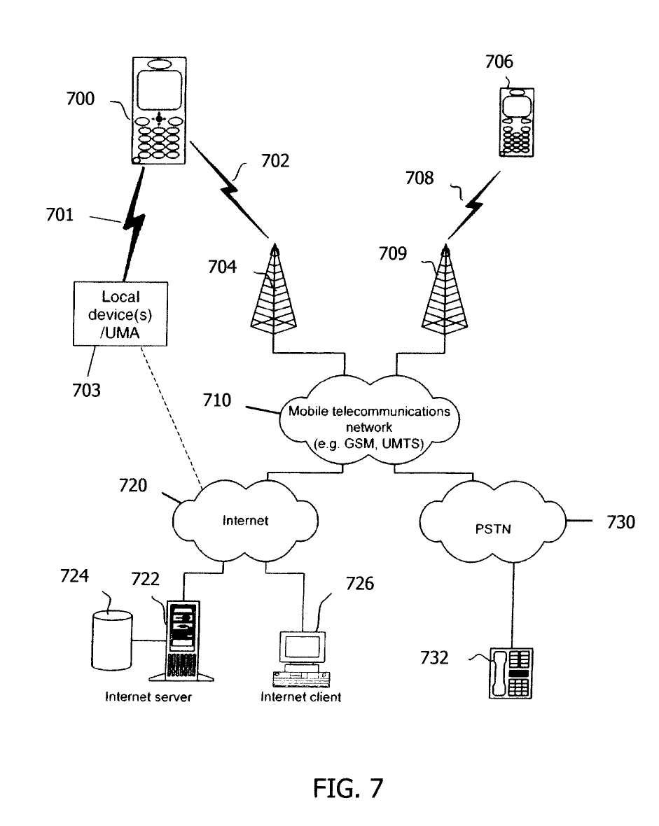

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 700 and other devices, such as another mobile terminal 706, a line telephone 732, a personal computer 751 and/or an internet server 122. In one embodiment the system is configured to enable any one or combination of chat messaging, instant messaging, text messaging and/or electronic mail. It is to be noted that for different embodiments of the mobile terminal 700 and in different situations, some of the telecommunications services indicated above may or may not be available. The aspects of the disclosed embodiments are not limited to any particular set of services in this respect.

The mobile terminals 700, 706 may be connected to a mobile telecommunications network 77 through radio frequency (RF) links 702, 708 via base stations 704, 709. The mobile telecommunications network 710 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 710 may be operatively connected to a wide area network 720, which may be the Internet or a part thereof. An Internet server 722 has data storage 724 and is connected to the wide area network 720, as is an Internet client computer 726. The server 722 may host a worldwide web/wireless application protocol server capable of serving worldwide web/wireless application protocol content to the mobile terminal 700.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 or 751 to one or more local devices 703 or 750. The local links 701 or 751 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting, and any suitable type of link may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 can include a communications module that is configured to interact with the system described with respect to FIG. 7.

Although the above embodiments are described as being implemented on and with a mobile communication device, it will be understood that the disclosed embodiments can be practiced on any suitable device incorporating a display, processor, memory and supporting software or hardware. For example, the disclosed embodiments can be implemented on various types of music players. In one embodiment, the system 100 of FIG. 1 may be for example, a personal digital assistant (PDA) style device 600′ illustrated in FIG. 6B. The personal digital assistant 600′ may have a keypad 610′, a touch screen display 620′, camera 621′ and a pointing device 650 for use on the touch screen display 620′. In still other alternate embodiments, the device may be a personal computer, a tablet computer, touch pad device, Internet tablet, a laptop or desktop computer, a mobile terminal, a cellular/mobile phone, a multimedia device, a personal communicator, a television or television set top box, a digital video/versatile disk (DVD) or High Definition player or any other suitable device capable of containing for example a display 114 shown in FIG. 1, and supported electronics such as the processor 618 and memory 602 of FIG. 6A. In one embodiment, these devices will be Internet enabled and can include map and GPS capability.

The user interface 102 of FIG. 1 can also include menu systems 124 coupled to the processing module 122 for allowing user input and commands. The processing module 122 provides for the control of certain processes of the system 100 including, but not limited to the controls for selecting multimedia files, establishing and selecting search and relationship criteria and navigating among the search results. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages and notifications. Depending on the inputs, the process module 122 interprets the commands and directs the process control 132 to execute the commands accordingly in conjunction with the other modules, such as search criteria engine 136, relationship engine 138 and multidimensional factors engine 140.

Referring again to FIG. 1, the display 114 of the system 100 can comprise any suitable display, such as noted earlier, a touch screen display, proximity screen device or graphical user interface. In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of a liquid crystal display (LCD) with optional back lighting, such as a thin film transistor (TFT) matrix capable of displaying color images. A touch screen may be used instead of a conventional liquid crystal display.

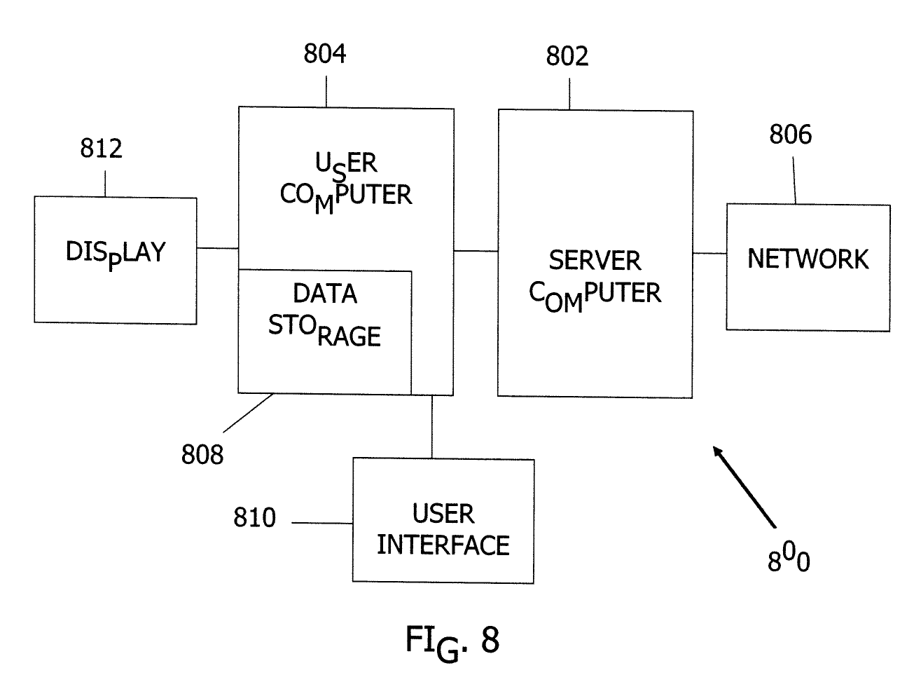

The disclosed embodiments may also include software and computer programs incorporating the process steps and instructions described above. In one embodiment, the programs incorporating the process steps described herein can be executed in one or more computers. FIG. 8 is a block diagram of one embodiment of a typical apparatus 800 incorporating features that may be used to practice aspects of the invention. The apparatus 800 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 800. The memory can be direct coupled or wireless coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Alternatively, where only one computer system is used, such as computer 804, computer 804 will be configured to communicate with and interact with the network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or through a dial-up connection on an integrated services digital network (ISDN) line or other such communication channel or link. In one embodiment, the communication channel comprises a suitable broad-band communication channel. Computers 802 and 804 are generally adapted to utilize program storage devices embodying machine-readable program source code, which is adapted to cause the computers 802 and 804 to perform the method steps and processes disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the invention may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries.

The aspects of the disclosed embodiments provide a direct access, touch based user interface that makes navigation through files and data items stored on, or remotely to a device, expedient and efficient. The contextual navigation of the list of files and data items can be based on a selection of similarity/dissimilarity. The overall look of the collection is not changed and offers step by step navigation in locating the desired content. User effort is diminished both in the number and the precision of inputs required and the number of steps to take. This provides advantages over visualizations that require expensive graphical capabilities.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
providing each data item identified in a device with at least one multi-dimensional descriptor;
selecting one component of the at least one multi-dimensional descriptor as an initial search criteria for a selected file;
identifying in the device all other data items that have a relationship with the initial criteria; and
presenting the identified items to the user.

2. The method of claim 1 further comprising selecting an additional search criteria or de-selecting a current search criteria and presenting a revised list of identified data items having a relationship with the selected criteria.

3. The method of claim 1 further comprising:
providing at least one search criterion on a display of the device, each search criterion corresponding at least in part to one of the at least one multi-dimensional descriptor;
selecting the initial search criterion from the at least one search criteria and identifying in the device all other data items that have a relationship with the initial search criterion;
selecting at least one other search criterion after the identified items are presented;
identifying in the device all other items that have a relationship with the selected search criteria to form a revised set of identified items; and
presenting the revised set of identified items to the user.

4. The method of claim 1 further comprising selecting an ordering relation for ordering the list of items, wherein the ordering relation can be based on one of most similar items, or least similar items, to the selected item.

5. The method of claim 4 further comprising identifying a relationship between each item on the list and the selected item by varying a highlight associated with each item on the list according to a strength of the relationship.

6. The method of claim 5 wherein a highlight for a strong relationship is represented by intensifying a display of an identifier for a strong relationship item and a highlight for a weak relationship is represented by fading a display of an identifier for a weak relationship item.

7. The method of claim 6 wherein the strong relationship indicates similarity between the selected item and the item on the list and the weak relationship indicates that the item on the list is a dissimilar item in comparison to the selected item.

8. The method of claim 1 further comprising exchanging an item on the list with the selected item, wherein the exchanged item becomes an active item on the device.

9. The method of claim 1 further comprising providing one or more search criteria on a display of the device, allowing the user to select or deselect one or more of the search criteria, and executing a search of all items stored on the device to identify items that have a relationship with the selected criteria.

10. The method of claim 9 further comprising selecting a relationship criteria prior to executing the search, the relationship criteria determining a strength of a relationship between the selected item and all other items stored in the device.

11. The method of claim further comprising the relationship criteria being one of similar items or dissimilar items.

12. The method of claim 1 wherein the multi-dimensional descriptor comprises a descriptive feature associated with a type of item.

13. The method of claim 1 wherein the selected item is a multi-media file.

14. The method of claim 13 wherein the multi-dimensional descriptor for a music file includes at least one of a value for tempo, rhythm, loudness, energy, vocal characteristics, singer name, title, and release year associated with the music file.

15. The method of claim 13 wherein the multi-dimensional descriptor for a image file includes at least one of a value for time taken, location, color balance and intensity variations.

16. The method of claim 1 wherein the selected item is a database item.

17. The method of claim 1 wherein the selected item is a contact from a contacts application.

18. The method of claim 1 wherein more than one search criteria can be selected as the initial search criteria.

19. The method of claim 18 wherein a search result set can include items that do not match each of the initial search criteria.

20. The method of claim 1 further comprising that a content of at least one item identified by the device is stored remotely from the device.

21. The method of claim 20 wherein the search includes searching metadata related to each item that is stored remotely from the device.

22. A method comprising:
selecting an anchor data item;
selecting at least one search criterion associated with the selected anchor data item from a set of search criterion;
executing a search for data items related to the anchor data item based on the selected search criterion; and
presenting a set of search results from the search.

23. The method of claim 22 further comprising:
selecting or deselecting at least one additional search criteria; and
automatically executing a search upon a selection or deslection of each additional search criteria.

24. The method of claim 22 wherein the search criterion are presented as activatable links.

25. The method of claim 22 wherein the search criterion are entered by the user into a search field.

26. The method of claim 22 further comprising selecting a data item from the set of search results as a new anchor item and re-executing a search upon selection of at least one search criterion.

27. The method of claim 22 further comprising that the search is automatically executed upon a selection of each search criterion.

28. An apparatus comprising:
a multidimensional factors engine configured to provide each item associated with a device with at least one multi-dimensional descriptor;
a search selection engine configured to select at least one multi-dimensional descriptor as an initial search criteria;
a search engine configured to execute a search based on the selected search criteria and identify all items associated with a related application in the device that have a relationship with the search criteria; and
a search results engine configured to order a result set at least naming the identified items and present the result set to the user.

29. The apparatus of claim 28 further comprising:
a search criteria engine configured to provide at least one search criteria on a display of the device, each search criteria corresponding at least in part to one of the at least one multi-dimensional descriptor; and wherein the search selection engine is configured to provide for:
selecting the initial search criteria from the at least one search criteria;
selecting at least one other search criteria after the result set is presented;
identifying all other items that have a relationship with the selected search criteria to form a revised search result set; and
presenting the revised search result set to the user.

30. The apparatus of claim 28 wherein an initial item is selected as a base item and the search criteria is related to the selected item

31. The apparatus of claim 30 wherein the selected item is a multi-media file.

32. The apparatus of claim 30 wherein the selected item is a data item corresponding to an application of the device.

33. The apparatus of claim 28 wherein a content of the at least one item is stored remotely from the device.

34. The apparatus of claim 33 wherein a file descriptor for each file stored remotely from the device includes at least one metadata tag that relates to the at least one multi-dimensional descriptor that can be searched by the search engine.

35. A computer program product stored in a memory comprising:
computer readable program code embodied in a computer readable medium for executing the method of claim 1.

36. A user interface comprising:
at least one selectable search criteria displayed on a display of a device; and
at least one data item identified as active in the device;
wherein when one of the search criteria is selected, a set of search results is automatically presented on the display, the search results set comprising data items identified in the device that have a relationship corresponding to the search criteria and the at least one active item.

37. The user interface of claim 36 further comprising that the set of search results is presented in a list, wherein a data item identified in the search results that has a strong relationship with the at least one active data item is presented in greater contrast on the display than a data item that has a weak relationship with the at least one active data item.

38. The user interface of claim 36 further comprising providing a user data input field for specifying a search criteria.

39. The user interface of claim 36 further comprising providing a window of additional search criteria or a search input field when a selection tool is positioned in a proximity of a selectable search criteria.
